(19) United States
(12) Patent Application Publication
(10) Pub. No.: US 2009/0176125 A1
(43) Pub. Date: Jul. 9, 2009

(54) Sn-Plated Cu-Ni-Si Alloy Strip

(75) Inventor: Takaaki Hatano, Kanagawa (JP)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Nippon Mining & Metals Co., Ltd., Minato-ku, Tokyo (JP)

(21) Appl. No.: 12/226,635

(22) PCT Filed: Apr. 26, 2007
(86) PCT No.: PCT/JP2007/059084

§ 371 Date: Oct. 23, 2008

(30) Foreign Application Priority Data
Apr. 26, 2006 (JP) 2006-121848

(51) Int. Cl. B32B 15/01; B21B 3/00

(52) U.S. Cl. 428/647; 72/199

(57) ABSTRACT

In a Sn-plated strip in which a copper base alloy contains 1.0 to 4.5 mass % of Ni, 0.2 to 1.0 mass % of Si and a balance of Cu and unavoidable impurities, an S concentration and a C concentration in a boundary between a plating layer and the base alloy are adjusted to 0.05 mass % or less, respectively. The base alloy may further contain 0.005 to 3.0 mass % in total of at least one selected from the group consisting of Sn, Zn, Mg, Fe, Mn, Co, Ti, Cr, Zr, Al and Ag. There is provided a Cu—Ni—Si base alloy Sn-plated strip in which the resistance to thermal peel of Sn plating has been improved.

### TECHNICAL FIELD

The present invention relates to an Sn-plated Cu—Ni—Si alloy strip which is suitable for a conductive material for a connector, a terminal, a relay, a switch or the like and has an excellent resistance to thermal peel.

### BACKGROUND ART

A copper alloy for an electronic material for use in a terminal, a connector or the like is required to have both high strength and high electric or thermal conductivity as alloy basic characteristics. Moreover, in addition to these characteristics, the copper alloy is required to possess bending workability, stress relaxing properties, heat resistance, adhesion properties to plating, solderability, etchability, press punching properties, corrosion resistance and the like.

In recent years, from the viewpoints of high strength and high conductivity, as the copper alloy for the electronic material, the usage of age-hardening copper alloys is increased, which replace conventional solid solution hardening copper alloys typified by phosphor bronze, brass or the like. In the age-hardening copper alloy, a supersaturated solid solution is subjected to an aging treatment to form uniformly dispersed fine precipitates, whereby the strength of the alloy increases, and simultaneously, the amount of dissolved elements in the copper decreases to improve the electric conductivity. Therefore, there is obtained a material which is excellent in mechanical properties such as strength and spring properties, and also has satisfactory electric and thermal conductivities.

Among age-hardening copper alloys, a Cu—Ni—Si base alloy is a typical copper alloy having both high strength and high conductivity. With respect to the Cu—Ni—Si base alloy, fine Ni—Si based intermetallic compound particles may be precipitated in a copper matrix resulting in increase of the strength and the conductivity. Cu—Ni—Si base alloys are practically used as materials for electronic apparatuses, and alloys such as C70250 and C64745 are standardized by Copper Development Association (CDA).

In the general manufacturing process of the Cu—Ni—Si base alloy, materials such as electrolytic cathode copper, Ni and Si are firstly dissolved under charcoal covering by use of an atmospheric melting furnace to obtain a molten metal having a desired composition. Then, this molten metal is cast into an ingot. Afterward, hot rolling, cold rolling and a heat treatment are performed to form a strip or a foil having desired thickness and characteristics.

When Cu—Ni—Si base alloy is used as an electric contact material, the alloy is often plated with Sn so as to stably obtain low contact resistance. A large amount of Sn-plated Cu—Ni—Si base alloy strips is used in electric and electronic components such as wire harness terminals for automobiles, terminals of printed circuit boards (PCB) and connector contacts for households, because Sn is excellent in solderability, corrosion resistance and electric connection properties.

Sn-plated Cu—Ni—Si base alloy strip is manufactured by steps of forming a base plating layer by an electric plating process after degreasing and pickling, then forming an Sn plating layer by an electric plating process, and finally performing a reflow treatment to melt the Sn plating layer.

As for the base plating of the Sn-plated Cu—Ni—Si base alloy strip, Cu base plating is generally employed, and Cu/Ni double layer base plating is sometimes performed for use where heat resistance is required. Here, in the above Cu/Ni double layer base plating, electric plating processes including Ni base plating, Cu base plating and Sn plating are performed in this order, followed by a reflow treatment. A plating film layer after the reflow treatment has a constitution in which an Sn phase, a Cu—Sn phase, an Ni phase and the base alloy are deposited in this order from the surface. Details of this technology are disclosed in Patent Documents 1 to 3 (JP06-196349A, JP2003-293187A and JP2004-68026A) and the like.

The Sn-plated Cu—Ni—Si base alloy strip has a weak point that, in a case where the strip is held at a high temperature for a long time, a phenomenon in which the plating layer peels from the base alloy (hereinafter referred to as the thermal peel) easily occurs, and attempts have heretofore been made to overcome the weak point. In Patent Document 4 (JP63-262448A), aging conditions are limited by use of hardness as an index in order to decrease the thermal peel. Patent Document 5 (JP05-59468A) describes that when an amount of Mg to be added for the improvement of stress relaxing properties is set to 0.1 mass % or less and when amounts of S and O which form a compound together with Mg and suppress an effect of improving the stress relaxing properties are set to 0.0015 mass %, the thermal peel can be improved.

[Patent Document 1] Japanese Patent Application Laid-Open No. 6-196349

[Patent Document 2] Japanese Patent Application Laid-Open No. 2003-293187

[Patent Document 3] Japanese Patent Application Laid-Open No. 2004-68026

[Patent Document 4] Japanese Patent Application Laid-Open No. 63-262448

[Patent Document 5] Japanese Patent Application Laid-Open No. 5-59468

### DISCLOSURE OF THE INVENTION

In recent years, a reliable resistance to thermal peel at a higher temperature for a longer time has been demanded, and a Cu—Ni—Si base alloy has been required to have a further satisfactory resistance to thermal peel as compared with the above-mentioned known techniques.

An object of the present invention is to provide a Sn-plated Cu—Ni—Si base alloy strip in which the resistance to thermal peel of Sn-plating has been improved. More particularly, it is to provide a Sn-plated Cu—Ni—Si base alloy strip having an improved resistance to thermal peel with respect to Cu base plating or Cu/Ni double layer base plating.

The present inventor has intensively investigated an approach for improving the resistance to thermal peel of the Sn-plated Cu—Ni—Si base alloy strip from a new standpoint. As a result, the inventor has found that when an S concentration and a C concentration in a boundary between a plating layer and a base alloy is minimized, the resistance to thermal peel is greatly improved.

The present invention has been developed based on this finding, and it is as follows.

(1) An Sn-plated Cu—Ni—Si alloy strip in which a copper base alloy contains 1.0 to 4.5 mass % of Ni, 0.2 to 1.0 mass % of Si and a balance of Cu and unavoidable impurities, and an S concentration and a C concentration in a boundary between a plating layer and the base alloy are 0.05 mass % or less, respectively.

(2) An Sn-plated Cu—Ni—Si alloy strip in which a copper base alloy contains 1.0 to 4.5 mass % of Ni, 0.2 to 1.0 mass % of Si and a balance of Cu and unavoidable impurities, the layers of an Sn phase, an Sn—Cu alloy phase and a Cu phase constitute a plating film from the surface to the base alloy, the Sn phase has a thickness of 0.1 to 1.5 μm, the Sn—Cu alloy phase has a thickness of 0.1 to 1.5 μm, the Cu phase has a thickness of 0 to 0.8 μm, and an S concentration and a C concentration in a boundary between a plating layer and the base alloy are 0.05 mass % or less, respectively.

(3) An Sn-plated Cu—Ni—Si alloy strip in which a copper base alloy contains 1.0 to 4.5 mass % of Ni, 0.2 to 1.0 mass % of Si and a balance of Cu and unavoidable impurities, the layers of an Sn phase, an Sn—Cu alloy phase and an Ni phase constitute a plating film from the surface to the base alloy, the Sn phase has a thickness of 0.1 to 1.5 μm, the Sn—Cu alloy phase has a thickness of 0.1 to 1.5 μm, the Ni phase has a thickness of 0.1 to 0.8 μm, and an S concentration and a C concentration in a boundary between a plating layer and the base alloy are set to 0.05 mass % or less, respectively.

(4) The Sn-plated Cu—Ni—Si alloy strip according to any one of (1) to (3), wherein the base alloy further contains 0.005 to 3.0 mass % in total of at least one selected from the group consisting of Sn, Zn, Mg, Fe, Mn, Co, Ti, Cr, Zr, Al and Ag.

(5) A manufacturing method of the Sn-plated Cu—Ni—Si alloy strip according to any one of (1) to (4), wherein the enclosing of rolling oil in the base alloy surface during final rolling is suppressed so as to adjust the S concentration and the C concentration in the boundary between the plating layer and the base alloy after reflow treatment to 0.05 mass % or less, respectively.

It is to be noted that the Sn plating of a Cu—Ni—Si base alloy includes a case where the plating is performed before press processing into a component (pre-plating) and a case where the plating is performed after the press processing (post-plating). In both of the cases, the effect of the present invention is obtained.

### BRIEF DESCRIPTION OF THE DRAWINGS

FIG. 1 is a schematic diagram showing a process in which rolling oil is enclosed in the surface of a strip to be rolled during cold rolling.

FIG. 2 shows a profile of an S concentration in a depth direction in Example 17 (Table 1, Cu base plating).

FIG. 3 shows a profile of a Cu concentration and an Sn concentration in a depth direction in Example 48 (Table 2, Cu base plating), and a portion of the Cu concentration profile shown in the square dotted line of (a) is enlarged and shown in (b).

### BEST MODE FOR CARRYING OUT THE INVENTION

(1) Composition of the Base Alloy

Ni and Si in a Cu—Ni—Si base alloy are subjected to an aging treatment so as to form fine intermetallic compound particles mainly composed of Ni₂Si. As a result, the strength of the alloy remarkably increases, and electric conductivity also increases.

In a case where an Ni concentration is less than 1.0 mass % and/or an Si concentration is less than 0.2 mass %, even when the other component is added, desired strength cannot be obtained. Moreover, when the Ni concentration exceeds 4.5 mass % and/or the Si concentration exceeds 1.0 mass %, sufficient strength is obtained, but conductivity deteriorates. Furthermore, coarse Ni—Si based particles (crystallized matters and precipitates) that do not contribute to the improvement of the strength are generated in a matrix, and as a result, bending workability, etchability and the like deteriorate. Therefore, the Ni concentration is in a range of 1.0 to 4.5 mass %, and the Si concentration is in a range of 0.2 to 1.0 masse. Preferably, the Ni concentration is in a range of 1.5 to 4.0 mass %, and the Si concentration is in a range of 0.3 to 0.9 mass %.

For a purpose of improving strength, stress relaxing properties and the like, the Cu—Ni—Si base alloy as a plating base alloy in the present invention may further contain at least one selected from the group consisting of Sn, Zn, Mg, Fe, Mn, Co, Ti, Cr, Zr, Al and Ag in a range of 0.005 to 3.0 mass %, preferably 0.05 to 2.1 mass % in total. When the total amount of these elements is less than 0.005 mass %, any effect is not obtained. When the total amount exceeds 3.0 mass %, conductivity remarkably deteriorates.

(2) S and C Concentrations in Boundary between Plating Layer and Base Alloy

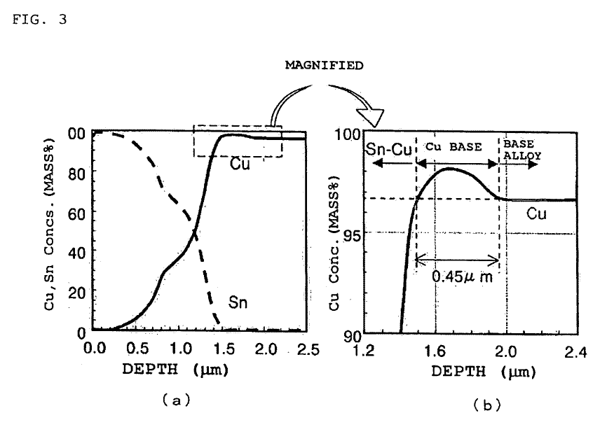

When an S concentration in a boundary between a plating layer and the base alloy exceeds 0.05 mass %, resistance to thermal peel deteriorates. Similarly, when a C concentration in the boundary between the plating layer and the base alloy exceeds 0.05 mass %, the resistance to thermal peel deteriorates. To solve the problem, each of the S concentration and the C concentration is 0.05 mass % or less. Here, the concentration in the boundary between the plating layer and the base alloy is the S or C concentration of a peak appearing in a position corresponding to the boundary between the Sn plating layer and the base alloy in the concentration profile of a degreased sample in a depth direction obtained by glow discharge spectrometry (GDS). That is, one peak appears in the S or C concentration profile of the sample in a depth direction (see FIG. 2), and this position corresponds to the boundary between the plating layer and the base alloy where an Sn concentration rapidly lowers and a Cu concentration rapidly increases in Cu and Sn concentration profiles in the depth direction (see FIG. 3).

Examples of manufacturing condition factors which affect the S and C concentrations in the boundary between the plating layer and the base alloy include final cold rolling conditions and the subsequent degreasing conditions. That is, rolling oil is used in the cold rolling, and hence the rolling oil is interposed between a roll and a strip to be rolled. When this rolling oil is enclosed in the surface of the strip to be rolled and the oil remains without being removed in the next degreasing step, S and C segregation layers are formed in the boundary between the plating layer and the base alloy through a plating step (electrodeposition and reflow treatment).

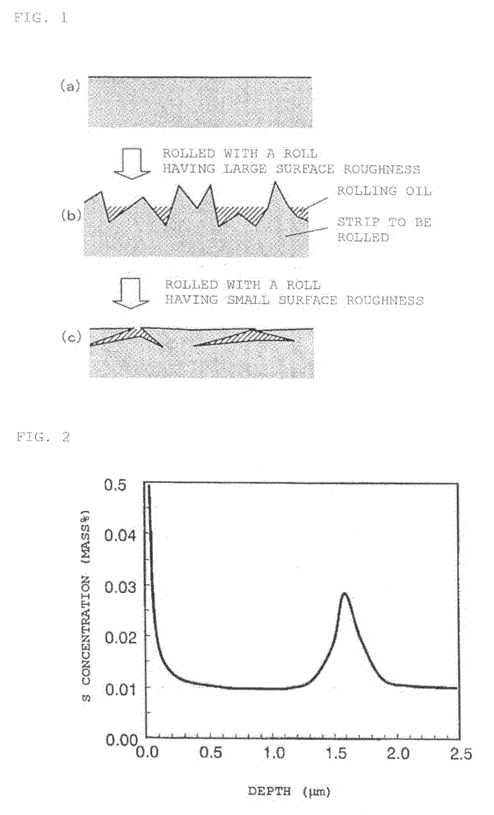

In the cold rolling step, rolling of a strip through a rolling mill is repeated to finish the strip into a predetermined thickness. FIG. 1 schematically shows a process in which the rolling oil is enclosed in the surface of the strip to be rolled during the rolling. Drawing (a) shows a cross section of a strip before rolled. (b) shows a cross section of a strip rolled using a usually used roll having large surface roughness. The surface of the rolled strip becomes uneven, and the rolling oil is filled in recess portions. (c) shows a cross section of a rolled strip using a roll having small surface roughness for the final pass after (b). The rolling oil filled in the recess portions as shown in (b) is enclosed in the surface of the strip.

FIG. 1 shows that, in order to suppress the enclosing of the rolling oil, it is important to use a roll having small surface roughness during a pass before the final pass in which a roll having small surface roughness is used. That is, when a roll having large surface roughness is used even once during all the passes before the final pass, unevenness is unfavorably generated in the surface of the strip to be rolled. Examples of an important factor other than the roll roughness include viscosity of rolling oil. The rolling oil having low viscosity and excellent fluidity is not easily enclosed in the surface of the strip to be rolled.

Examples of a method for decreasing the surface roughness of a roll include a method by polishing the surface of the roll by use of a grinding wheel having a fine abrasive grain size, and a method by plating the roll surface. However, these methods require considerable effort and cost. When the surface roughness of the roll is decreased, various problems or troubles arise such that slippage tends to occur between the roll surface and the strip to be rolled, thus rolling speed cannot be increased (efficiency deteriorates). Therefore, a roll having small surface roughness is used in the final pass in order to adjust the surface roughness of a product, but the use of a roll having small surface roughness in a pass other than the final pass has been avoided by any person skilled in the art. The use of rolling oil having low kinematic viscosity has also been avoided for the reasons such that the roll surface is more worn down than use of usual one.

The present inventor has for the first time found that decreasing of the S and C concentrations of the boundary between the plating layer and the base alloy is important for the improvement of the resistance to thermal peel of Sn plating. Then, it has been revealed that when a roll having small surface roughness is used during a pass previous to the final pass and the rolling oil having low kinematic viscosity and satisfactory fluidity is used, the enclosing of the rolling oil is effectively suppressed.

The maximum height of profile (roughness) Rz of a roll having small surface roughness used prior to the final pass is preferably 1.5 μm or less, more preferably 1.0 μm or less, most preferably 0.5 μm or less. When the roughness Rz exceeds 1.5 μm, rolling oil is easily enclosed, and the S and C concentrations in the boundary do not easily decrease. Moreover, the kinematic viscosity of the rolling oil for use (measured at 40° C.) is preferably 15 mm²/s or less, more preferably 10 mm²/s or less, most preferably 5 mm²/s or less. When the viscosity exceeds 15 mm²/s, the rolling oil is easily enclosed, and the S and C concentrations in the boundary do not easily decreased.

It is to be noted that in Patent Document 3, the C concentration is noted, but this C concentration is the average C concentration of the Sn plating layer, and is different from the C concentration in the boundary between the plating layer and the base alloy which is one of the constituent factors of the present invention. In Patent Document 3, an average C concentration of the Sn plating layer changes in accordance with the amount of a brightener or an additive in a plating solution and a plating current density. When the C concentration of Patent Document 3 is less than 0.001 mass %, unevenness in the thickness of the Sn plating is generated while when the C concentration exceeds 0.1 mass %, contact resistance increases. Therefore, it is obvious that the approach and technique of Patent Document 3 are different from these of the present invention.

Moreover, in Patent Document 5, an S concentration is noted, but this S concentration is the average S concentration in the base alloy, and is different from the S concentration in the boundary between the plating layer and the base alloy which is one of the constituent factors of the present invention. An object of Patent Document 5 is to obtain an improving effect of the stress relaxing properties even in a case where Mg has a low concentration, thus the S concentration of the base alloy which forms compound with Mg is 0.0015 mass % or less. Therefore, it is obvious that the approach and technique of Patent Document 5 are different from these of the present invention.

(3) Thickness of Plating

(3-1) Cu Base Plating

In Cu base plating, a Cu plating layer and an Sn plating layer are successively formed on a Cu—Ni—Si base alloy by electric plating processes, and then a reflow treatment is performed. By this reflow treatment, the Cu plating layer reacts with the Sn plating layer to form an Sn—Cu alloy phase. In a plating layer structure, an Sn phase, an Sn—Cu alloy phase and a Cu phase are deposited from a surface side.

After reflow treatment, the thicknesses of the phases are adjusted as follows.

Sn phase: 0.1 to 1.5 μm

Sn—Cu alloy phase: 0.1 to 1.5 μm

Cu phase: 0 to 0.8 μm

When the thickness of the Sn phase is less than 0.1 μm, solderability deteriorates. When the thickness exceeds 1.5 μm, increased is a thermal stress generated in the plating layer by heating, and peeling of plating is promoted. The thickness of the Sn phase is more preferably in a range of 0.2 to 1.0 μm.

Since the Sn—Cu alloy phase is hard, the presence of the phase having a thickness of 0.1 μm or more contributes to the decrease of an insertion force. On the other hand, when the thickness of the Sn—Cu alloy phase exceeds 1.5 μm, increased is a thermal stress generated in the plating layer by heating, and the peeling of plating is promoted. The thickness of the Sn—Cu alloy phase is more preferably in a range of 0.5 to 1.2 μm.

When a Cu—Ni—Si base alloy is subjected to Cu base plating, the solderability improves. Therefore, Cu base plating should be performed by electrodeposition such that a thickness of Cu base plating becomes 0.1 μm or more. This Cu base plating may be consumed and disappeared in the course of forming an Sn—Cu alloy phase during the reflow treatment. That is, there is not any special restriction on the lower limit value of the Cu phase thickness after reflow treatment, and the thickness might be zero.

The thickness of the Cu phase is 0.8 μm or less in a state after reflow treatment. When the value exceeds 0.8 μm, increased is a thermal stress generated in the plating layer by heating, and peeling of plating is promoted. The thickness of the Cu phase is more preferably 0.4 μm or less.

To obtain the above plating structure, the Sn plating thickness is appropriately adjusted to a range of 0.5 to 1.8 μm, and the Cu plating thickness is appropriately adjusted to a range of 0.1 to 1.2 μm, after respective electric plating processes. The reflow treatment is performed on appropriate conditions in ranges of 230 to 600° C. and three to 30 seconds.

(3-2) Cu/Ni Base Plating

In Cu/Ni base plating, an Ni plating layer, a Cu plating layer and an Sn plating layer are successively formed on the Cu—Ni—Si base alloy by electric plating process, and then reflow treatment is performed. By this reflow treatment, the Cu plating reacts with Sn to form an Sn—Cu alloy phase, and the Cu phase disappears. On the other hand, the Ni layer substantially holds and remains a state and a thickness obtained immediately after the electric plating. As a result, in a plating layer structure, an Sn phase, an Sn—Cu alloy phase and a Ni phase are deposited from the surface side.

After reflow treatment, the thicknesses of the phases are adjusted as follows.

Sn phase: 0.1 to 1.5 μm

Sn—Cu alloy phase: 0.1 to 1.5 μm

Ni phase: 0.1 to 0.8 μm

When the thickness of the Sn phase is less than 0.1 μm, the solderability deteriorates while when the thickness exceeds 1.5 μm, increased is a thermal stress generated in the plating layer by heating, and peeling of plating is promoted. The thickness of the Sn phase is more preferably in a range of 0.2 to 1.0 μm.

Since the Sn—Cu alloy phase is hard, the presence of the phase having a thickness of 0.1 μm or more contributes to the decrease of the insertion force. On the other hand, when the thickness of the Sn—Cu alloy phase exceeds 1.5 μm, increased is a thermal stress generated in the plating layer by heating, and peeling of plating is promoted. The thickness of the Sn—Cu alloy phase is more preferably in a range of 0.5 to 1.2 μm.

The thickness of the Ni phase is in a range of 0.1 to 0.8 μm. When the Ni thickness is less than 0.1 μm, corrosion resistance and heat resistance of the plating deteriorate while when the Ni thickness exceeds 0.8 μm, increased is a thermal stress generated in the plating layer by heating, and peeling of plating is promoted. The thickness of the Ni phase is more preferably in a range of 0.1 to 0.3 μm.

To obtain the above plating structure, the Sn plating thickness is appropriately adjusted to a range of 0.5 to 1.8 μm, the Cu plating thickness is appropriately adjusted to a range of 0.1 to 0.4 Mm, and the Ni plating thickness is appropriately adjusted to a range of 0.1 to 0.8 μm, after respective electric plating processes. The reflow treatment is performed on appropriate conditions in ranges of 230 to 600° C. and three to 30 seconds.

### EXAMPLES

Manufacturing of an alloy, plating and measurement methods employed in examples of the present invention will hereinafter be described.

2 kg of electrolytic cathode copper was dissolved in a graphite crucible having an inner diameter of 60 mm and a depth of 200 mm by use of a high-frequency induction furnace. After covering the surface of a molten metal with a charcoal piece, Ni, Si and another alloy element were added with predetermined amounts. Afterward, the molten metal was cast in a mold to manufacture an ingot having a width of 60 mm and a thickness of 30 mm. In the following steps, a Cu base reflowed Sn plating strip and a Cu/Ni base reflowed Sn plating strip were processed. To obtain samples having different S and C concentrations of a plating/base alloy interface (boundary), conditions of Step 7 were changed.

(Step 1) Strips were heated at 950° C. for three hours, and hot-rolled into a thickness of 8 mm.

(Step 2) Oxidized scales on the surfaces of hot-rolled plates were ground and removed with a grinder.

(Step 3) The plates were cold-rolled into a thickness of 0.5 mm.

(Step 4) As a solid solution treatment, the plates were heated at 800° C. in the atmosphere for ten seconds, and rapidly quenched in water.

(Step 5) As for an aging treatment, the plates were heated at 470° C. in a nitrogen gas for six hours, and gradually cooled.

(Step 6) Pickling with a 10 mass % of sulfuric acid-1 mass % of hydrogen peroxide solution and mechanical polishing with #1200 emery paper were successively performed to remove a surface oxidized film.

(Step 7) The cold rolling was performed until a plate thickness of 0.3 mm was obtained. The number of passing operations was set to two. The plates were processed into a thickness of 0.38 mm in the first pass, and processed into a thickness of 0.3 mm in the second pass. In the second pass, a roll having surface roughness Rz (maximum height of profile) adjusted to 0.5 μm was used. In the first pass, the roughness Rz of the roll surface was changed into four levels of 0.5, 1.0, 1.5 and 2.0 μm. Moreover, the kinematic viscosity of rolling oil (common to the first and second pass) was changed into three levels of 5, 10 and 15 mm²/s.

(Step 8) The resultant samples as cathodes were electrolytically degreased in an aqueous alkali solution on the following conditions: a current density of 3 A/dm²; a degreasing agent: trademark “PAKUNA P105” manufactured by YUKEN Industry CO., LTD.; a degreasing agent concentration of 40 g/L; temperature: 50° C.; time: 30 seconds; and a current density of 5 A/dm².

(Step 9) The samples were acid-washed using 10 mass % of an aqueous sulfuric acid solution. (Step 10) The samples were subjected to Ni base plating on the following conditions (only in the case of a Cu/Ni base):

Plating bath composition: 250 g/L of nickel sulfate, 45 g/L of nickel chloride and 30 g/L of boric acid

Plating bath temperature: 50° C.

Current density: 5 A/dm²

The Ni plating thickness was adjusted in accordance with electrodeposition time.

(Step 11) The samples were subjected to Cu base plating on the following conditions:

Plating bath composition: 200 g/L of copper sulfate, 60 g/L of sulfuric acid

Plating bath temperature: 25° C.

Current density: 5 A/dm²

The Cu plating thickness was adjusted in accordance with the electrodeposition time.

(Step 12) The samples were subjected to Sn plating on the following conditions.

Plating bath composition: 41 g/L of tin II oxide (stannous oxide), 268 g/L of phenolsulfonic acid and 5 g/L of surfactant

Plating bath temperature: 50° C.

Current density: 9 A/dm²

The Sn plating thickness was adjusted in accordance with the electrodeposition time.

(Step 13) As a reflow treatment, the samples were inserted into a heating furnace of an atmospheric gas replaced with nitrogen (1 vol % or less of oxygen) at a temperature of 400° C. for ten seconds, and they were water-quenched.

The samples thus prepared were evaluated as follows.

(a) Base Alloy Component Analysis

After complete removal of the plating layers by mechanical grinding and chemical etching, the concentrations of Ni, Si and the other alloy element were measured by ICP-emission spectrography.

(b) Plating Thickness Measurement with Electrolytic Film Thickness Meter

The thicknesses of the Sn phase and the Sn—Cu alloy phase of each of the samples after reflow treatment were measured. It is to be noted that the thicknesses of the Cu phase and the Ni phase cannot be measured by this method.

(c) Surface Analysis by GDS

After ultrasonically degreasing in acetone of the samples after reflow treatment, the concentration profiles of Sn, Cu, Ni, S and C in a depth direction were obtained by glow discharge spectrometry (GDS). Measurement conditions were as follows.

Pretreatment of the samples: ultrasonic degreasing in acetone

Device: JY5000RF-PSS model manufactured by JOBIN YBON Co.

Current method program: CNBinteel-12aa-0

Mode: Constant electric power=40 W

Ar-pressure: 775 Pa

Current value: 40 mA (700 V)

Flush time: 20 sec.

Preburn time: 2 sec.

Determination time: analysis time=30 sec., Sampling time=0.020 sec./point

S and C concentrations of a plating/base alloy boundary were obtained from S and C concentration profile data obtained by GDS. As a representative S concentration profile, the data of Example 17 described later (Table 1, Cu base plating) is shown in FIG. 2. An S peak is recognized in a position having a depth of 1.6 μm (a boundary between a plating layer and a base alloy). The height of this peak was read to obtain the S concentration of the plating/base alloy boundary. The concentration profile of C was obtained in the same manner as in S, and the C concentration of the plating/base alloy boundary was obtained by the same procedure.

Moreover, thickness of the Cu base plating (the Cu phase) remaining after reflow treatment was obtained from the Cu concentration profile obtained by GDS. FIG. 3 shows data of Example 48 described later (Table 2, Cu base plating). In a position having a depth of 1.7 μm, a layer having a Cu concentration higher than that of the base alloy is recognized. This layer is the Cu base plating remaining after reflow treatment. A range having the Cu concentration higher than that of the base alloy of this layer was read and regarded as a thickness of the Cu phase. It is to be noted that in a case where any layer having a Cu concentration higher than that of the base alloy was not recognized, it was judged that the Cu base plating disappeared (the thickness of the Cu phase was zero). Similarly, the thickness of Ni base plating (an Ni phase) was obtained from a Ni concentration profile data obtained by GDS.

(d) Resistance to Thermal Peel

A strip test piece having a width of 10 mm was sampled and heated to a temperature of 160° C. in the atmosphere for 3000 hours. During the heating, at intervals of 100 hours, the sample was taken from a heating furnace and bent to an angle of 90° with a bend radius of 0.5 mm and returned (the sample was bent to 90° in a reciprocating manner). Next, an adhesive tape (#851 manufactured by 3M Co.) was attached to and peeled from the inner peripheral surface of the bent range. Afterward, the inner peripheral surface of the bent range of the sample was observed with an optical microscope (a magnification of 50) to check the presence of peeling of plating. Then, heating time elapsed until the peeling of plating was generated (peeling time) was obtained.

### Relationship Between S and C Concentrations of the Plating Layer/Base Alloy Interface and Resistance to Thermal Peel Examples and Comparative Examples 1 to 45

Table 1 shows examples in which the effects of S and C concentrations of the plating layer/base alloy interfaces on the resistance to thermal peel were checked. In Step 7, roll surface roughness Rz and rolling oil kinematic viscosity of each of the base alloys of Groups A to P were adjusted to a range of 0.5 to 1.5 μm and a range of 5 to 15 mm²/s, respectively, in order to change the S and C concentrations of the plating layer/base alloy interface.

As to a Cu base plating strip, electric plating processes were performed such that the thickness of Cu was 0.3 μm, the thickness of Sn was 1.0 μm. Reflow treatment was performed at 400° C. for ten seconds. Then, in all the examples and comparative examples, the thickness of the Sn phase was about 0.6 μm, the thickness of the Cu—Sn alloy phase was about 1 μm, and the Cu phase disappeared.

As to a Cu/Ni base plating strip, electric plating processes were performed such that, the thickness of Ni was 0.3 μm, the thickness of Cu was 0.3 μm, the thickness of Sn was 0.8 μm. Reflow treatment was performed at 400° C. for ten seconds. Then, in all the examples and comparative examples, the thickness of the Sn phase was about 0.4 μm, the thickness of the Cu—Sn alloy phase was about 1 μm, and the Cu phase disappeared. However, the Ni phase having the thickness (0.3 μm) after electrodeposition remained as it was.

As to Group A, in Examples 1 to 6, the S concentration and the C concentration of the plating layer/base alloy interface were both 0.05 mass % or less. Even when the samples were heated at 160° C. for 3000 hours, any peeling of plating was not observed. On the other hand, in Comparative Examples 7 to 12, the S or C concentration exceeded 0.05 mass %, hence peeling time was below 3000 hours. It is recognized that as to the influences of the rolling conditions, when the surface roughness of the roll is decreased and the viscosity of the rolling oil is decreased, the S and C concentrations of the plating layer/base alloy interface decreases.

In Groups B to P, the influences of the base alloy elements were recognized (the peeling time lengthened by virtue of the addition of Zn, and shortened owing to the addition of Mg and the like), but the peeling times of examples were obviously longer than these of the comparative examples. It is recognized that when the S and C concentrations are adjusted to 0.05 mass % or less, the resistance to thermal peel is improved.

TABLE 1

| | | | | | | | Kinematic | | | | |
|---|---|---|---|---|---|---|---|---|---|---|---|
| | | | Composition of | | | | viscosity | Conc. of plating | | Peeling time | |
| | | | base alloy (mass %) | | | Rz of | of rolling | interface (mass %) | | at 160° C. (h) | |
| Group & No. | | | Ni | Si | Others | roll (μm) | oil (mm²/s) | S | C | Cu base | Cu/Ni base |
| A | 1 | Ex. | 1.6 | 0.35 | 0.40Zn, 0.50Sn | 0.5 | 5 | <0.01 | <0.01 | >3000 | >3000 |
| | 2 | Ex. | 1.6 | 0.35 | 0.40Zn, 0.50Sn | 1.0 | 5 | 0.01 | 0.02 | >3000 | >3000 |
| | 3 | Ex. | 1.6 | 0.35 | 0.40Zn, 0.50Sn | 1.5 | 5 | 0.02 | 0.04 | >3000 | >3000 |
| | 4 | Ex. | 1.6 | 0.35 | 0.40Zn, 0.50Sn | 0.5 | 10 | 0.02 | 0.02 | >3000 | >3000 |
| | 5 | Ex. | 1.6 | 0.35 | 0.40Zn, 0.50Sn | 1.0 | 10 | 0.04 | 0.04 | >3000 | >3000 |
| | 6 | Ex. | 1.6 | 0.35 | 0.40Zn, 0.50Sn | 0.5 | 15 | 0.04 | 0.03 | >3000 | >3000 |
| | 7 | Com. Ex. | 1.6 | 0.35 | 0.40Zn, 0.50Sn | 1.0 | 15 | 0.06 | 0.05 | 1900 | 2400 |
| | 8 | Com. Ex. | 1.6 | 0.35 | 0.40Zn, 0.50Sn | 2.0 | 5 | 0.04 | 0.06 | 2200 | 2900 |
| | 9 | Com. Ex. | 1.6 | 0.35 | 0.40Zn, 0.50Sn | 1.5 | 10 | 0.06 | 0.06 | 1500 | 2200 |
| | 10 | Com. Ex. | 1.6 | 0.35 | 0.40Zn, 0.50Sn | 2.0 | 10 | 0.07 | 0.07 | 1200 | 2000 |
| | 11 | Com. Ex. | 1.6 | 0.35 | 0.40Zn, 0.50Sn | 1.5 | 15 | 0.08 | 0.07 | 1200 | 2200 |
| | 12 | Com. Ex. | 1.6 | 0.35 | 0.40Zn, 0.50Sn | 2.0 | 15 | 0.10 | 0.08 | 900 | 1500 |
| B | 13 | Ex. | 2.8 | 0.63 | 0.40Zn, 0.50Sn | 1.0 | 5 | 0.01 | 0.02 | >3000 | >3000 |
| | 14 | Ex. | 2.8 | 0.63 | 0.40Zn, 0.50Sn | 1.5 | 5 | 0.02 | 0.03 | >3000 | >3000 |
| | 15 | Com. Ex. | 2.8 | 0.63 | 0.40Zn, 0.50Sn | 1.0 | 15 | 0.06 | 0.06 | 1500 | 2300 |
| C | 16 | Ex. | 1.6 | 0.35 | — | 0.5 | 5 | <0.01 | 0.01 | 2200 | >3000 |
| | 17 | Ex. | 1.6 | 0.35 | — | 1.0 | 10 | 0.03 | 0.04 | 2000 | >3000 |
| | 18 | Com. Ex. | 1.6 | 0.35 | — | 2.0 | 10 | 0.07 | 0.07 | 900 | 2500 |
| D | 19 | Ex. | 2.3 | 0.47 | 0.12Mg | 1.0 | 5 | 0.02 | 0.02 | 1500 | 2600 |
| | 20 | Ex. | 2.3 | 0.47 | 0.12Mg | 1.0 | 10 | 0.04 | 0.05 | 1400 | 2500 |
| | 21 | Com. Ex. | 2.3 | 0.47 | 0.12Mg | 1.5 | 10 | 0.07 | 0.06 | 300 | 1200 |
| E | 22 | Ex. | 1.8 | 0.40 | 1.1Zn, 0.11Sn | 1.0 | 10 | 0.04 | 0.04 | >3000 | >3000 |
| | 23 | Com. Ex. | 1.8 | 0.40 | 1.1Zn, 0.11Sn | 1.5 | 10 | 0.07 | 0.06 | 1300 | 2400 |
| F | 24 | Ex. | 2.0 | 0.45 | 1.0Zn, 0.50Sn | 1.5 | 5 | 0.02 | 0.04 | >3000 | >3000 |
| | 25 | Com. Ex. | 2.0 | 0.45 | 1.0Zn, 0.50Sn | 1.0 | 15 | 0.07 | 0.04 | 1800 | 2700 |
| G | 26 | Ex. | 3.8 | 0.80 | 0.10Mg, 0.15Mn | 0.5 | 5 | <0.01 | <0.01 | 1200 | 2500 |
| | 27 | Com. Ex. | 3.8 | 0.80 | 0.10Mg, 0.15Mn | 2.0 | 15 | 0.11 | 0.09 | 500 | 1600 |
| H | 28 | Ex. | 2.5 | 0.53 | 1.7Zn, 0.03P | 1.0 | 5 | 0.01 | 0.01 | >3000 | >3000 |
| | 29 | Com. Ex. | 2.5 | 0.53 | 1.7Zn, 0.03P | 1.5 | 10 | 0.07 | 0.06 | 1200 | 2000 |
| I | 30 | Ex. | 3.0 | 0.60 | 1.7Zn, 0.03P, 0.3Sn | 1.5 | 5 | 0.02 | 0.04 | >3000 | >3000 |
| | 31 | Com. Ex. | 3.0 | 0.60 | 1.7Zn, 0.03P, 0.3Sn | 2.0 | 10 | 0.07 | 0.06 | 1200 | 2300 |
| J | 32 | Ex. | 2.3 | 0.55 | 0.10Mg, 0.15Sn, 0.5Zn | 1.0 | 5 | 0.01 | 0.02 | 2800 | >3000 |
| | 33 | Com. Ex. | 2.3 | 0.55 | 0.10Mg, 0.15Sn, 0.5Zn | 1.5 | 15 | 0.08 | 0.07 | 1000 | 1800 |
| K | 34 | Ex. | 3.2 | 0.70 | 1.0Zn, 0.5Sn | 1.5 | 5 | 0.02 | 0.04 | >3000 | >3000 |
| | 35 | Com. Ex. | 3.2 | 0.70 | 1.0Zn, 0.5Sn | 1.0 | 15 | 0.06 | 0.05 | 1700 | 2400 |
| L | 36 | Ex. | 3.7 | 0.80 | 0.10Mg, 0.15Sn, 0.5Zn | 1.0 | 5 | 0.01 | 0.02 | 1800 | 2800 |
| | 37 | Com. Ex. | 3.7 | 0.80 | 0.10Mg, 0.15Sn, 0.5Zn | 1.5 | 10 | 0.06 | 0.06 | 700 | 1500 |
| M | 38 | Ex. | 2.7 | 0.60 | 1.3Zn, 0.3Sn | 0.5 | 5 | 0.01 | <0.01 | >3000 | >3000 |
| | 39 | Com. Ex. | 2.7 | 0.60 | 1.3Zn, 0.3Sn | 2.0 | 10 | 0.07 | 0.08 | 1100 | 2200 |
| N | 40 | Ex. | 2.0 | 0.42 | 0.1Cr, 0.05Zr, 0.05Al | 1.5 | 5 | 0.02 | 0.04 | 2500 | >3000 |
| | 41 | Com. Ex. | 2.0 | 0.42 | 0.1Cr, 0.05Zr, 0.05Al | 1.0 | 15 | 0.06 | 0.06 | 900 | 2400 |
| O | 42 | Ex. | 1.8 | 0.38 | 0.2Ag, 0.1Fe | 1.0 | 5 | 0.02 | 0.02 | 2200 | >3000 |
| | 43 | Com. Ex. | 1.8 | 0.38 | 0.2Ag, 0.1Fe | 1.5 | 10 | 0.06 | 0.07 | 700 | 2200 |
| P | 44 | Ex. | 2.5 | 0.53 | 0.05Ti, 0.1Co | 1.0 | 5 | 0.01 | 0.02 | 2400 | >3000 |
| | 45 | Com. Ex. | 2.5 | 0.53 | 0.05Ti, 0.1Co | 1.5 | 10 | 0.07 | 0.06 | 600 | 1900 |

“—” in the table indicates additive-free.

### Relationship Between Plating Thickness and Resistance to Thermal Peel (Examples and Comparative Examples 46 to 66)

Tables 2 and 3 show examples in which the influence of the plating thickness on the resistance to thermal peel was studied. Composition of the base alloy was Cu-1.6 mass % Ni-0.35 mass % Si-0.4 mass % Zn-0.5 mass % Sn. In Step 7, a roll having a roughness Rz of 1.0 μm was used in the first pass, and rolling oil having a kinematic viscosity of 5 mm²/s was used in the first and second pass. As a result, the S and C concentrations of the plating layer/base alloy interface in each sample fell in a range of 0.03 mass % or less.

TABLE 2

| | | Thickness after electrodeposition (μm) | | | Thickness after Reflow Treatment (μm) | | | Peeling time at |
|---|---|---|---|---|---|---|---|---|
| No | | Sn Phase | Cu Phase | Reflow conditions | Sn Phase | Sn—Cu Phase | Cu Phase | 160° C. |
| Ex. | 46 | 0.90 | 0.20 | 400° C. × 10 sec. | 0.49 | 0.98 | 0.00 | >3000 |
| | 47 | 0.90 | 0.50 | 400° C. × 10 sec. | 0.48 | 1.03 | 0.11 | >3000 |
| | 48 | 0.90 | 0.80 | 400° C. × 10 sec. | 0.50 | 1.02 | 0.45 | >3000 |
| | 49 | 0.90 | 1.00 | 400° C. × 10 sec. | 0.51 | 1.04 | 0.70 | >3000 |
| | 50 | 0.50 | 0.80 | 400° C. × 10 sec. | 0.12 | 1.00 | 0.50 | >3000 |
| | 51 | 0.60 | 0.80 | 400° C. × 10 sec. | 0.23 | 1.02 | 0.51 | >3000 |
| | 52 | 1.20 | 0.80 | 400° C. × 10 sec. | 0.77 | 1.03 | 0.49 | >3000 |
| | 53 | 1.80 | 0.80 | 400° C. × 10 sec. | 1.43 | 1.02 | 0.48 | >3000 |
| Com. | 54 | 2.00 | 0.80 | 400° C. × 10 sec. | 1.53 | 0.83 | 0.45 | 1500 |
| Ex. | 55 | 2.00 | 0.80 | 400° C. × 10 sec. | 1.15 | 1.56 | 0.10 | 1400 |
| | 56 | 0.90 | 1.25 | 400° C. × 10 sec. | 0.45 | 1.15 | 0.83 | 1600 |

TABLE 3

| | | Thickness after electrodeposition (μm) | | | | Thickness after Reflow Treatment (μm) | | | Peeling time at |
|---|---|---|---|---|---|---|---|---|---|
| No | | Sn Phase | Cu Phase | Ni Phase | Reflow conditions | Sn Phase | Sn—Cu Phase | Ni Phase | 160° C. |
| Ex. | 57 | 0.90 | 0.20 | 0.15 | 400° C. × 10 sec. | 0.50 | 1.01 | 0.14 | >3000 |
| | 58 | 0.90 | 0.20 | 0.50 | 400° C. × 10 sec. | 0.49 | 0.97 | 0.47 | >3000 |
| | 59 | 0.90 | 0.20 | 0.70 | 400° C. × 10 sec. | 0.48 | 1.01 | 0.69 | >3000 |
| | 60 | 0.50 | 0.15 | 0.20 | 400° C. × 10 sec. | 0.14 | 1.00 | 0.21 | >3000 |
| | 61 | 0.60 | 0.15 | 0.20 | 400° C. × 10 sec. | 0.25 | 1.04 | 0.20 | >3000 |
| | 62 | 1.20 | 0.15 | 0.20 | 400° C. × 10 sec. | 0.77 | 0.97 | 0.19 | >3000 |
| | 63 | 1.80 | 0.15 | 0.20 | 400° C. × 10 sec. | 1.26 | 1.02 | 0.21 | >3000 |
| Com. | 64 | 2.00 | 0.15 | 0.20 | 400° C. × 10 sec. | 1.54 | 1.01 | 0.21 | 2500 |
| Ex. | 65 | 2.00 | 0.60 | 0.20 | 400° C. × 10 sec. | 1.32 | 1.57 | 0.20 | 2300 |
| | 66 | 0.90 | 0.20 | 0.90 | 400° C. × 10 sec. | 0.48 | 0.99 | 0.88 | 2400 |

Table 2 (Examples and Comparative Examples 46 to 56) shows data in Cu base plating. In Examples 46 to 53 of the alloys according to the present invention, even when the samples were heated at 160° C. for 3000 hours, any peeling of plating was not observed.

In Examples 46 to 49 and Comparative Example 56, the thickness of Sn after electrodeposition was set to 0.9 μm, while Cu base thickness was changed. In Comparative Example 56 in which the Cu base thickness after reflow treatment exceeded 0.8 μm, hence the peeling time was below 3000 hours.

In Examples 48, 50 to 53 and Comparative Examples 54 and 55, the thickness of the Cu base after the electrodeposition was set to 0.8 μm, while Sn thickness was changed. In Comparative Example 54 in which the Sn thickness after electrodeposition was 2.0 μm and reflow treatment was performed on the same conditions as those of the others, thus the thickness of the Sn phase after the reflow treatment exceeded 1.5 μm. Moreover, in Comparative Example 55 in which the Sn thickness after electrodeposition was 2.0 μm and the reflow treatment time was extended, the thickness of the Sn—Cu alloy phase after the reflow treatment exceeded 1.5 μm. In these alloys in which the thickness of the Sn phase or the Sn—Cu alloy phase exceeded a predetermined range, the peeling times were below 3000 hours.

Table 3 (Examples and Comparative Examples 57 to 66) show the data in Cu/Ni base plating. In Examples 57 to 63 of the alloys according to the present invention, even when the samples were heated for 3000 hours, any peeling of plating was not observed.

In Examples 57 to 59 and Comparative Example 66, the thickness of Sn after electrodeposition was set to 0.9 μm, the thickness of Cu after electrodeposition was set to 0.2 μm while Ni base thickness was changed. In Comparative Example 66 in which the thickness of the Ni phase after reflow treatment exceeded 0.8 μm, hence the peeling time was below 3000 hours.

In Examples 60 to 63 and Comparative Example 64, thickness of the Cu base after electrodeposition was set to 0.15 μm, thickness of the Ni base after electrodeposition was set to 0.2 Mm while Sn thickness was changed. In Comparative Example 64 in which the thickness of the Sn phase after the reflow treatment exceeded 1.5 μm, hence the peeling time was below 3000 hours.

In Comparative Example 65 in which the thickness of Sn after electrodeposition was set to 2.0 μm, the thickness of Cu during the electrodeposition was set to 0.6 μm and the reflow treatment time was extended as compared with the others, the thickness of the Sn—Cu alloy phase exceeded 1.5 μm, hence the peeling time was below 3000 hours.

1. An Sn-plated Cu—Ni—Si alloy strip in which a copper base alloy contains 1.0 to 4.5 mass % of Ni, 0.2 to 1.0 mass % of Si and a balance of Cu and unavoidable impurities, and an S concentration and a C concentration in a boundary between a plating layer and the base alloy are set to 0.05 mass % or less, respectively.

2. An Sn-plated Cu—Ni—Si alloy strip in which a copper base alloy contains 1.0 to 4.5 mass % of Ni, 0.2 to 1.0 mass % of Si and a balance of Cu and unavoidable impurities, the layers of an Sn phase, an Sn—Cu alloy phase and a Cu phase constitute a plating film from the surface to the base alloy, the Sn phase has a thickness of 0.1 to 1.5 μm, the Sn—Cu alloy phase has a thickness of 0.1 to 1.5 μm, the Cu phase has a thickness of 0 to 0.8 μm, and an S concentration and a C concentration in a boundary between a plating layer and the base alloy are set to 0.05 mass % or less, respectively.

3. An Sn-plated Cu—Ni—Si alloy strip in which a copper base alloy contains 1.0 to 4.5 mass % of Ni, 0.2 to 1.0 mass % of Si and a balance of Cu and unavoidable impurities, the layers of an Sn phase, an Sn—Cu alloy phase and an Ni phase constitute a plating film from the surface to the base alloy, the Sn phase has a thickness of 0.1 to 1.5 μm, the Sn—Cu alloy phase has a thickness of 0.1 to 1.5 μm, the Ni phase has a thickness of 0.1 to 0.8 μm, and an S concentration and a C concentration in a boundary between a plating layer and the base alloy are set to 0.05 mass % or less, respectively.

4. The Sn-plated Cu—Ni—Si alloy strip according to claim 1, wherein the base alloy further contains 0.005 to 3.0 mass % in total of at least one selected from the group consisting of Sn, Zn, Mg, Fe, Mn, Co, Ti, Cr, Zr, Al and Ag.

5. A manufacturing method of the Sn-plated Cu—Ni—Si alloy strip according to claim 1, wherein the enclosing of rolling oil in the base alloy surface during final rolling is suppressed so as to adjust the S concentration and the C concentration in the boundary between the plating layer and the base alloy after reflow treatment to 0.05 mass % or less, respectively.

6. The Sn-plated Cu—Ni—Si alloy strip according to claim 2, wherein the base alloy further contains 0.005 to 3.0 mass % in total of at least one selected from the group consisting of Sn, Zn, Mg, Fe, Mn, Co, Ti, Cr, Zr, Al and Ag.

7. The Sn-plated Cu—Ni—Si alloy strip according to claim 3, wherein the base alloy further contains 0.005 to 3.0 mass % in total of at least one selected from the group consisting of Sn, Zn, Mg, Fe, Mn, Co, Ti, Cr, Zr, Al and Ag.

8. A manufacturing method of the Sn-plated Cu—Ni—Si alloy strip according to claim 2, wherein the enclosing of rolling oil in the base alloy surface during final rolling is suppressed so as to adjust the S concentration and the C concentration in the boundary between the plating layer and the base alloy after reflow treatment to 0.05 mass % or less, respectively.

9. A manufacturing method of the Sn-plated Cu—Ni—Si alloy strip according to claim 3, wherein the enclosing of rolling oil in the base alloy surface during final rolling is suppressed so as to adjust the S concentration and the C concentration in the boundary between the plating layer and the base alloy after reflow treatment to 0.05 mass % or less, respectively.

10. A manufacturing method of the Sn-plated Cu—Ni—Si alloy strip according to claim 4, wherein the enclosing of rolling oil in the base alloy surface during final rolling is suppressed so as to adjust the S concentration and the C concentration in the boundary between the plating layer and the base alloy after reflow treatment to 0.05 mass % or less, respectively.

11. A manufacturing method of the Sn-plated Cu—Ni—Si alloy strip according to claim 6, wherein the enclosing of rolling oil in the base alloy surface during final rolling is suppressed so as to adjust the S concentration and the C concentration in the boundary between the plating layer and the base alloy after reflow treatment to 0.05 mass % or less, respectively.

12. A manufacturing method of the Sn-plated Cu—Ni—Si alloy strip according to claim 7, wherein the enclosing of rolling oil in the base alloy surface during final rolling is suppressed so as to adjust the S concentration and the C concentration in the boundary between the plating layer and the base alloy after reflow treatment to 0.05 mass % or less, respectively.
